(19) United States
(12) Patent Application Publication
(10) Pub. No.: US 2006/0278034 A1
(43) Pub. Date: Dec. 14, 2006

(54) Fluidic steering wheel

(76) Inventors: Mark Daly, Novi, MI (US); John Schroeder, Redford, MI (US)

Correspondence Address: FORD GLOBAL TECHNOLOGIES, LLC., FAIRLANE PLAZA SOUTH, SUITE 800, 330 TOWN CENTER DRIVE, DEARBORN, MI, 48126, US

(21) Appl. No.: 11/151,383

(22) Filed: Jun. 13, 2005

(51) Int. Cl. B62D 1/04

(52) U.S. Cl. 74/552

(57) ABSTRACT

A steering wheel assembly having a tuned absorber for damping a vibration of a motor vehicle. The steering wheel assembly has a hub and a substantially circular rim connected to the hub by a plurality of spokes extending between the hub and the rim. A hollow tube is affixed to an interior portion of the rim. A rigid plug is inside the hollow tube. A fluid substance is inside the hollow tube. A gaseous substance is inside the hollow tube. The gaseous substance is interposed between the fluid substance and the rigid plug.

### BACKGROUND OF THE INVENTION

The present invention relates generally to tuned dynamic absorbers and, in particular, to a steering wheel dynamic absorber assembly.

It is known that when a sinusoidal force acts on a lightly damped mass-spring system, and the forcing frequency equals the natural frequency of the system, the response grows to large amplitudes. This kind of large amplitude response is called resonance, and can be very troublesome for vibrating systems. When an absorbing mass-spring system is attached to the main mass and the resonance of the absorber is tuned to match that of the main mass, the vibration of the main mass is reduced at its resonance frequency. Therefore, the energy of the main mass is “absorbed” by the tuned dynamic absorber.

Steering wheel nibble or rotational vibration is a customer concern in many production automobiles today. In some vehicles steering wheel nibble is the result of the chassis system responding to the tire and wheel force variations which eventually feed back in the form of slight rotations in the steering system. Original equipment manufacturers and their suppliers are investigating chassis modifications to address and reduce the steering wheel nibble. However, these modifications often have negative effects on other vehicle characteristics and cost. Packaging difficulties and excessive weight penalties have traditionally made the application of tuned absorbers undesirable. Packaging difficulties have led to solutions in the steering wheel hub such as U.S. Pat. No. 6,296,416 to Oreans et al. However, a larger mass becomes necessary in order to attenuate the range of nibble experienced. A robust system needs expanded range in order to handle both large and small excitations. In a tuned absorber when the mass is small, the spring must be small as well. In those cases, the stickion which represents the friction between the mass and the housing on which the mass might move, has to be overcome before the tuned absorber can work affectively. In some systems this phenomenon can result in inconsistent performance during small excitations.

Solutions housed in the rim have also been proposed. For example, U.S. Patent Application Publication 2004/0050203 to Oblizajek et al., discloses a steering wheel dynamic absorber assembly. The chord length of the circumference of an average steering wheel is more than 1100 mm. However, the travel for most mechanical damper systems is often only between 5 and 10 mm, at which point the mass usually comes in contact with an abrupt non-linearity that restricts its travel therefore limiting the effectiveness.

During manufacturing of conventional steering wheels, a coating is attached to an exterior surface of the steering wheel rim. Similarly, in the Oblizajek design, the inertial ring and the support flexures (dynamic absorber components) must be protected by a protective cover during application of the coating to allow all for proper operation of the dynamic absorber. Unfortunately, the additional mechanical parts can cause increased rattles and noise.

What is needed is a low cost solution that will reduce steering wheel nibble at a given frequency that can be made integral to the steering wheel rim and without adversely affecting other vehicle system attributes.

### SUMMARY OF THE INVENTION

The present invention is a steering wheel assembly having a tuned absorber for damping a vibration of a motor vehicle. The steering wheel assembly comprises a hub and a substantially circular rim connected to the hub by a plurality of spokes extending between the hub and the rim. A hollow tube is affixed to an interior portion of the rim. A rigid plug is inside the hollow tube. A fluid substance is inside the hollow tube. A gaseous substance is inside the hollow tube. The gaseous substance is interposed between the fluid substance and the rigid plug.

One advantage of the present invention is that it packages in the circumference of the steering wheel rim maximizing the ratio of nibble attenuation per mass added to the system. The steering wheel assembly is easily integrated into the manufacturing process. Specifically, the application of steering wheel coatings during the conventional manufacturing process for steering wheels does not interfere with the tuned absorber performance.

The present invention has improved NVH characteristics as a fluid system compared to a mechanical tuned absorber system by using significantly fewer parts which account for reduced opportunities for squeak, rattle or noise. It also has an expanded performance range to handle both large and small excitations by eliminating the challenge of stiction from the system. The liquid mass of the fluid damper can travel back and forth with amplitudes many times that of the excitation amplitude compared to conventional mechanical systems without experiencing an abrupt end-of-travel stop.

The above and other aspects of the invention will be readily apparent to one of ordinary skill in the art in view of the attached drawings and following detailed description of the illustrated embodiment.

### DESCRIPTION OF THE DRAWINGS

FIG. 1 is a perspective view of a steering wheel assembly in accordance with the present invention;

FIG. 2 is a cross sectional view of a steering wheel assembly in accordance with the present invention;

FIG. 3 is a graphical representation of the present invention as a spring;

FIG. 4 is a cross sectional view of a steering wheel assembly in accordance with the present invention having a hollow non-structural member in accordance with the present invention:

FIG. 5 is a perspective view of an alternative embodiment of the steering wheel assembly in accordance with the present invention;

FIG. 6 is a perspective view of an alternative embodiment of the steering wheel assembly in accordance with the present invention;

FIG. 7 is a perspective view of an alternative embodiment of the steering wheel assembly in accordance with the present invention;

FIG. 8 is a perspective view of an alternative embodiment of the steering wheel assembly having a trap in accordance with the present invention;

FIG. 9 is a perspective view of an alternative embodiment of a trap in accordance with the present invention;

FIG. 10 is a cross sectional view of a trap in accordance with the present invention;

FIG. 11 is an end view of a trap in accordance with the present invention.

### DETAILED DESCRIPTION OF THE PREFERRED EMBODIMENTS

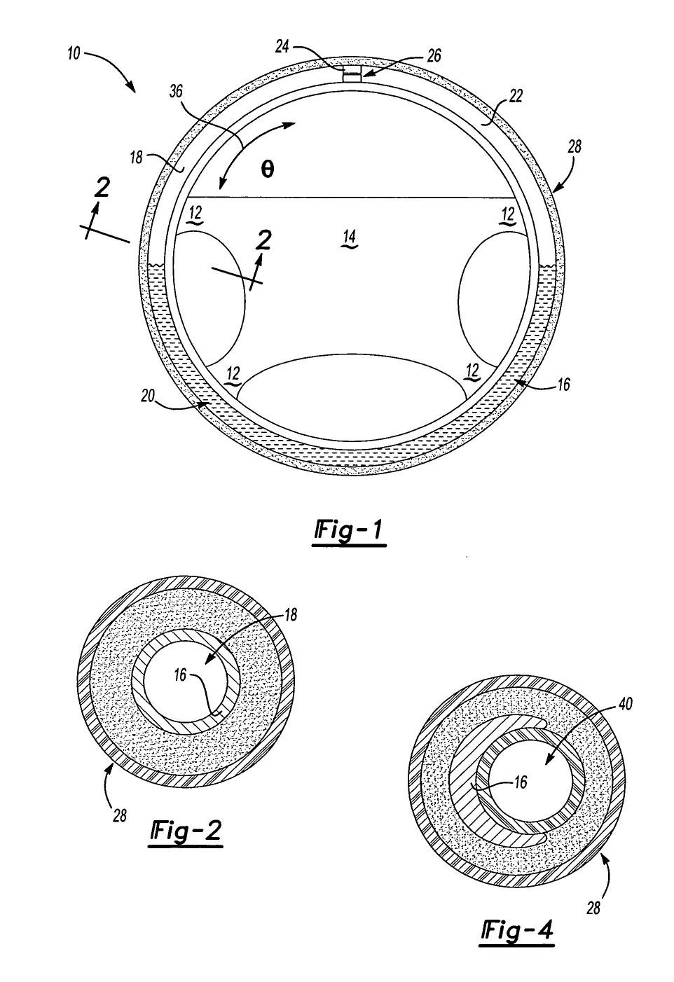

In FIG. 1, a steering wheel 10 according to the present invention is shown. Several spokes 12 extend radially from a hub 14 to attach to a rim 16. The rim comprises a hollow tube 18. The tube 18 contains a fluid 20, a compressed gas 22, and a rigid plug 24. The rigid plug contains an orifice 26. On the rim 16 a casing 28 is arranged which can be gripped by a driver of a vehicle employing the steering wheel.

Referring to FIG. 2, a cross-section of the rim 16, the casing 28 and the hollow tube 18 of a steering wheel according to one embodiment is shown. Tube 18 is the structural member of the steering wheel. The tube is made from tubular steel. In the alternative, aluminum or another metal or non-metals may be used. The tube 18 serves as the fluid chamber. The tube has a circular cross-section. However, the tube may have a more oblong or oval shaped curvature.

Referring to FIG. 1, the rigid plug 24 serves as a barrier inside of the tube 18 and is fixed to the tube at the 12 o'clock steering wheel position. The fluid 20 is free to travel inside of the tube on either side of the rigid plug 24. The compressed gas 22 fills the spaces between the fluid 20 and the rigid plug 24. In the preferred embodiment the fluid is a water glycol mixture. In the preferred embodiment the compressed gas is air.

During normal operation, the steering wheel is in an un-rotated position and the fluid is gathered in the lower portion of the tube as shown in FIG. 1. In one aspect of this invention, the tube may contain approximately 100 grams of fluid which is free to travel inside the tube. As the steering wheel experiences small rotations in the angular direction as shown by arrow 36, the rigid plug 24 pushes on the compressed gas 22, which acts like a spring. The compress gas spring then exerts a force on the fluid 20 gathered in the lower portion of the tube 18. The fluid 20 acts like a mass. The compressed gas spring 22 and the fluid mass 20 resonate at the natural frequency of this single degree of freedom (DOF) system. The stiffness of the compressed gas spring 22 is linearly proportional to the static pressure in the tube. The control of the static pressure in the tube 18 provides a convenient method for tuning the natural frequency of the absorber.

The small orifice 26 in the rigid plug 24 compensates for large, low frequency, steering wheel rotations of greater than 180 degrees. These occurrences may create situations where there is more compressed gas 22 on one side of the fluid 20, than on the other. The orifice 26 allows the static fluid level on each side of the plug to equalize over several seconds by allowing the compressed gas 22 to flow through the orifice 26 but preventing the fluid from flowing through the orifice 26.

The damping of the absorber may also be controlled by the viscosity of the fluid 20 or by changing the surface of the inside of the tube 18. Scoring or roughing the internal surface of the tube effectively acts to change the mass of the system. The damping of the absorber may also be controlled by the diameter of the orifice in the rigid plug.

The following equations describe the required distribution of stiffness and properties among the fluid 20 and compress gas 22 of the present invention.

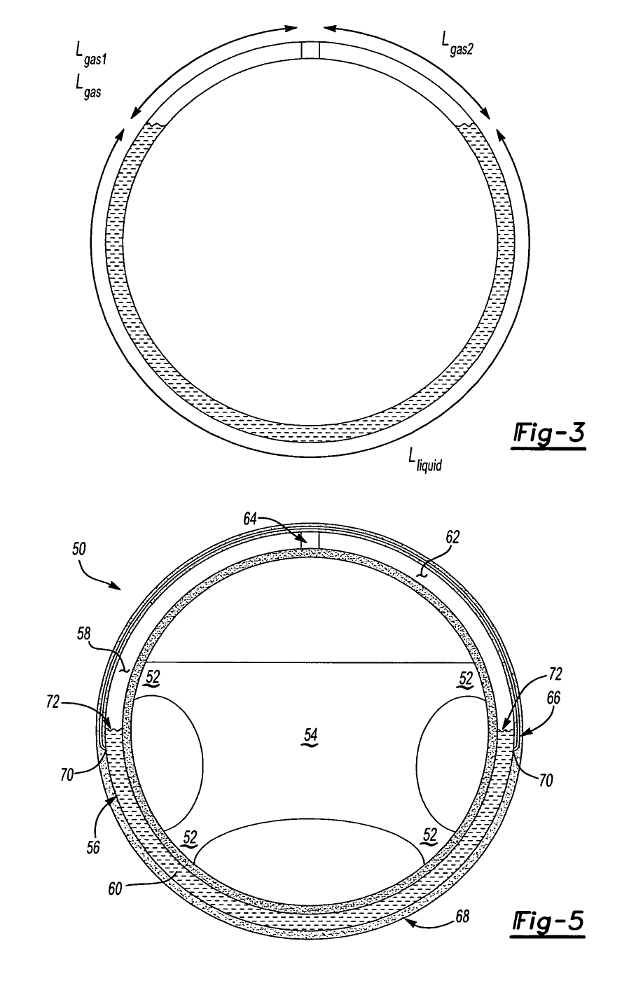

Referring now to FIG. 3, the components of the steering wheel rim 16 generally are shown. Assume tube 18 has constant area A and arc lengths L_{gas1}, L_{gas2}, and L_{liquid}. The basic equation for resonance frequency of a tuned absorber is shown;
2πf=\sqrt{k/m}

Assume tube has constant area A and arc lengths L_{gas1}, L_{gas2}, and L_{liquid}.
The stiffness for each of the two compressible gas chambers;

$${k}_{1} = \frac{γ {P}_{o} A}{{L}_{gas 1}} and {k}_{2} = \frac{γ {P}_{o} A}{{L}_{gas 2}}$$

where γ is the adiabatic constant for the gas and Pₒ is the mean absolute pressure in the tube. The stiffnesses of the two compressible gas chambers act in parallel and can therefore be combined;

$$k = {k}_{1} + {k}_{2} = \frac{γ {P}_{o} A}{{L}_{gas 1}} + \frac{γ {P}_{o} A}{{L}_{gas 2}} = \frac{2 γ {P}_{o} A}{{L}_{gas}}$$

where the liquid is centered at the bottom of the wheel so that L_{gas1} equals L_{gas2}.
The mass of the incompressible liquid;
m=ρAL_{liquid}
where ρ is the density of the liquid
Resulting equation for resonance frequency of fluidic damper:

$$2 π f = \sqrt{\frac{2 γ {P}_{o}}{ρ {L}_{liquid} {L}_{gas}}}$$

The effectiveness of the steering wheel assembly as a damper is proportional to the rotation inertia of the absorber. The rotational inertia, I, is dependent on the mass of the absorber, m, and the distance of the center of rotation to the mass center, R, are according to the following equation:
I=mR²

The large radius, R, which represents where the absorber is located in the system, makes it very effective. Specifically, because the absorber is located at radius R of the steering wheel, it is possible to provide the most attenuation ability with the least amount of added mass as an absorber. This minimizes the amount of addition mass integrated into the overall steering wheel system of the vehicle.

Referring to FIG. 3, the rigid barrier at the 12 o'clock position occupies only about 10 mm of chord length, while the liquid column occupies about 300% to 800 mm of chord length. The remainder of the chord length of the steering wheel rim, 300 to 800 mm, contains the pressurized gas that acts as two springs of the damper. Therefore, each pressurized gas spring is about 150 to 400 mm long. The length of these springs is about 10 to 20 times greater than the springs of the mechanical dampers discloses in the prior art. Furthermore, the usable travel for each of the pressurized gas springs is about 125 to 375 mm. This results in a total available travel for the fluid mass of 250 to 750 mm. The travel for some prior art mechanical damper systems is 5 to 10 mm, at which point the mass usually comes in contact with an abrupt non-linearity that restricts its travel. The liquid mass of the present fluid damper can travel back and forth with amplitudes many times that of the excitation amplitude without meeting any abrupt end-of-travel stops.

FIG. 4 discloses an alternative embodiment wherein the plastic fluid chamber is no longer a structural member of the rim 16. The rim 16 is made from a magnesium casting that is designed to provide package space for a plastic fluid chamber 40 as shown. The fluid chamber 40 is located next to the rim 16. In the alternative, the magnesium cast rim 16 may be of an alternative material such as aluminum.

Referring now to FIG. 5, an alternative embodiment of the present invention is shown. A steering wheel 50 is generally shown having several spokes 52 extending from a hub 54 and connected to a rim 56. The rim comprises an internal tube 58 equal distant from the hub. The internal tube 58 contains a fluid 60, a compressed gas 62, and a rigid plug 64. The rigid plug 64 separates two portions of the compressed gas 62. The rigid plug is fixed at the 12 o'clock location. A cross-over tube 66 extends between two sides of the rigid plug 64. The cross-over tube 66 allows the system to quickly equalize. The cross-over tube is designed such that at least one end 70 is below the fluid surface 71 when the fluid is equalized. This causes the fluid 20 to block additional compressed gas 22 from entering the cross-over tube 66 so that the system functions correctly.

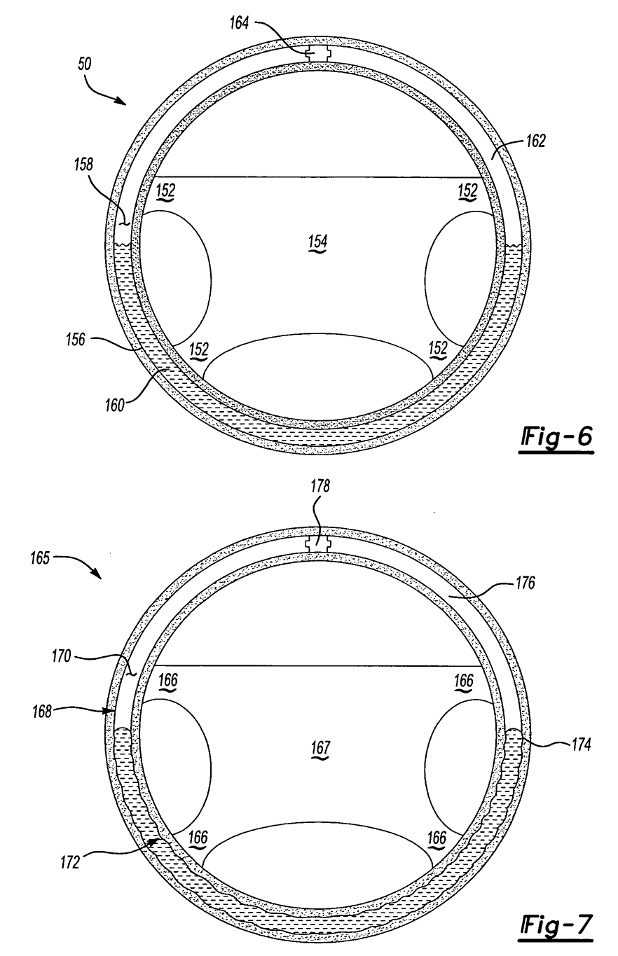

Referring now to FIG. 6, an alternative embodiment of the present invention is shown. A steering wheel 150 is generally shown having several spokes 152 extending from a hub 154 and connected to a rim 156. The rim comprises an internal tube 158 equal distant from the hub. The internal tube 158 contains a non-newtonian fluid 160, a compressed gas 162, and a rigid plug 164. The non-newtonian fluid 160 may be a gelatin, sludge, or slime. The non-newtonian characteristics of the fluid prevent a gas bubble from traveling through the fluid, eliminating the need for an equalization mechanism. The rigid plug 164 separates two portions of the compressed gas 162. The rigid plug is fixed at the 12 o'clock location. A cross-over tube 166 extends between two sides of the rigid plug 164.

Referring now to FIG. 7, an alternative embodiment of the present invention is shown. A steering wheel 165 is generally shown having several spokes 166 extending from a hub 167 and connected to a rim 168. The rim comprises an internal tube 170 equal distant from the hub. The internal tube 170 contains a fluid 172 contained inside a bag 174, a compressed gas 176, and a rigid plug 178. The fluid 172 is sealed inside an elongated, doughnut shaped, plastic bag 174. The bag 174 contains the fluid 172 in such a way as to prevent a gas bubble from from traveling through the fluid. The rigid plug 178 separates two portions of the compressed gas 176. The rigid plug is fixed at the 12 o'clock location. The fluid-in-a-bag design eliminates the need for an equalization mechanism.

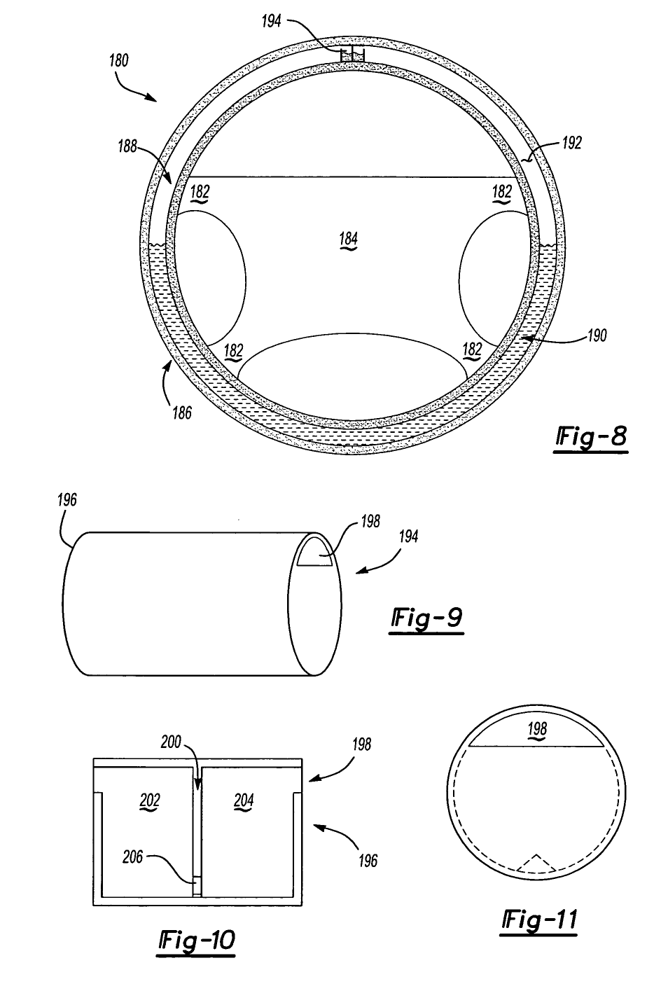

Referring now to FIG. 8, an alternative embodiment to the present invention is shown. Steering wheel 180 is generally shown having several spokes 182 extending from a hub 184 and connected to a rim 186. The rim comprises an internal tube 188 equal distant from the hub 184. The internal tube 188 contains a fluid 190, a compressed gas 192 and a trap 194. The trap 194 separates two portions of the compressed gas 192. The trap 194 is fixed at the 12 o'clock position and is better shown in FIGS. 8-11.

FIGS. 8-11 provides one embodiment of the trap 194. The trap is contoured to allow for it to mate with the internal tube 188. Two parallel walls 196 form the outer walls of the trap. There are holes 198 at the top of the outer walls 196. A third interior wall 200 is parallel to the outer walls 196 in order to form two adjacent chambers 202, 204. A third hole 206 is present at the bottom of the interior common wall 200. The trap 194 is designed such that there is always present a small amount of fluid 190 in one or both of chambers 202, 204. When the fluid level 206, 208 in the internal tube 188 is uneven, the pressure differential forces bubbles from one of the adjacent chambers 202, 204 to the other. The fluid 190 plugs up the interior hole 206 in the inner common wall 200 when the system is equalized allowing normal fluid absorber operation.

While the best mode for carrying out the invention has been described in detail, those familiar with the art to which this invention relates will recognize various alternative designs and embodiments for practicing the invention as defined by the following claims.

What is claimed:

1. A steering wheel assembly having a tuned absorber for damping a vibration of a motor vehicle, the steering wheel assembly comprising:
a hub;
a substantially circular rim connected to the hub by a plurality of spokes extending between the hub and the rim;
a hollow tube affixed to an interior portion of the rim;
a rigid plug inside the hollow tube;
a fluid substance inside the hollow tube; and
a gaseous substance inside the hollow tube
wherein the gaseous substance is interposed between the fluid substance and the rigid plug.

2. The apparatus according to claim 1, wherein the rigid plug is fixedly located inside the hollow tube.

3. The apparatus according to claim 2, wherein the rigid plug is located at a top center position inside the hollow tube.

4. The apparatus according to claim 1, wherein the fluid substance comprises a mixture of water and glycol.

5. The apparatus according to claim 1, wherein the gaseous substance is compressed air.

6. The apparatus according to claim 1, wherein the rigid plug further includes an orifice.

7. A steering wheel assembly having a tuned absorber damping vibration for a motor vehicle, the steering wheel assembly comprising:
a hub;
a substantially circular rim connected to the hub by a plurality of spokes extending between the hub and the rim;
a hollow non-structural member affixed to an interior portion of the rim;
a rigid plug inside the hollow non-structural member;
a fluid substance inside the hollow non-structural member; and
a gaseous substance inside the hollow non-structural member
wherein the gaseous substance is interposed between the fluid substance and the rigid plug.

8. The apparatus according to claim 7, wherein the rigid plug is fixedly located inside the hollow tube.

9. The apparatus according to claim 8, wherein the rigid plug is located at a top center position inside the hollow tube.

10. The apparatus of claim 7, wherein the fluid substance comprises a mixture of water and glycol.

11. The apparatus of claim 7, wherein the gaseous substance is compressed air.

12. The apparatus according to claim 7, wherein the rigid plug further includes an orifice.

13. A steering wheel assembly having a tuned absorber for damping a vibration of a motor vehicle, the steering wheel assembly comprising:
a hub;
a substantially circular rim connected to the hub by a plurality of spokes extending between the hub and the rim;
a hollow tube affixed to an interior portion of the rim;
a rigid plug inside the hollow tube;
a fluid substance inside the hollow tube;
a gaseous substance inside the hollow tube; and
a conduit connected to the hollow tube having a first connecting point and a second connecting point;
wherein the rigid plug is interposed between the first connecting point and the second connecting point, the gaseous substance is interposed between the fluid substance and the rigid plug, and one of the connecting points engages the gaseous substance inside the hollow tube.

14. The apparatus according to claim 13, wherein the rigid plug is fixedly located inside the hollow tube.

15. The apparatus according to claim 14, wherein the rigid plug is located at a top center position inside the hollow tube.

16. The apparatus according to claim 13, wherein the fluid substance comprises a mixture of water and glycol.

17. The apparatus according to claim 13, wherein the gaseous substance is compressed air.

18. A steering wheel assembly having a tuned absorber for damping a vibration of a motor vehicle, the steering wheel assembly comprising:
a hub;
a substantially circular rim connected to the hub by a plurality of spokes extending between the hub and the rim;
a hollow tube affixed to an interior portion of the rim;
a rigid plug inside the hollow tube;
a non-newtonian fluid substance inside the hollow tube; and
a gaseous substance inside the hollow tube
wherein the gaseous substance is interposed between the fluid substance and the rigid plug.

19. The apparatus according to claim 18, wherein the rigid plug is fixedly located inside the hollow tube.

20. The apparatus according to claim 19, wherein the rigid plug is located at a top center position inside the hollow tube.

21. The apparatus according to claim 18, wherein the gaseous substance is compressed air.

22. A steering wheel assembly having a tuned absorber for damping a vibration of a motor vehicle, the steering wheel assembly comprising:
a hub;
a substantially circular rim connected to the hub by a plurality of spokes extending between the hub and the rim;
a hollow tube affixed to an interior portion of the rim;
a rigid plug inside the hollow tube;
an oblong inflatable bag containing a fluid substance, the bag of fluid substance interposed inside the hollow tube; and
a gaseous substance inside the hollow tube
wherein the gaseous substance is interposed between the bag of fluid substance and the rigid plug.

23. The apparatus according to claim 22, wherein the rigid plug is fixedly located inside the hollow tube.

24. The apparatus according to claim 23, wherein the rigid plug is located at a top center position inside the hollow tube.

25. The apparatus according to claim 22, wherein the gaseous substance is compressed air.
